(19) United States
(12) Patent Application Publication
(10) Pub. No.: US 2006/0046734 A1
(43) Pub. Date: Mar. 2, 2006

(54) Method for radio system resource managment

(76) Inventors: Elena Costa, Munchen (DE); Harald Haas, Bremen (DE); Matthias Lott, Nueried (DE); Egon Schultz, Munchen (DE)

Correspondence Address: STAAS & HALSEY LLP, SUITE 700, 1201 NEW YORK AVENUE, N.W., WASHINGTON, DC, 20005, US

(21) Appl. No.: 10/532,346

(22) PCT Filed: Oct. 23, 2003
(86) PCT No.: PCT/EP03/11898

§ 371 Date: Apr. 22, 2005

(30) Foreign Application Priority Data
Oct. 24, 2002 (EP) 02023913.3

(51) Int. Cl. H04Q 7/20

(52) U.S. Cl. 455/452.1; 455/450

(57) ABSTRACT

Radio system resource management is provided in a cellular radio communication network like a multiple-carrier network. Information is transmitted on at least one frequency range consisting of a plurality of sub-carriers. The sub-carriers of the frequency range are temporarily made available to each cellular radio for transmitting information. The sub-carriers of the frequency range are temporarily assigned to a given number of cellular radios in such a way that each assigned sub-carrier is made available to a set of the cellular radios for information transmission. In the transmission framework, the assignment of information necessary for a transmission decision reduces the signalling complexity to a single symbol OFDM, thereby reducing interferences and increasing spectrum efficiency.

### CROSS REFERENCE TO RELATED APPLICATIONS

This application is based on and hereby claims priority to European Application No. 02023913.3 filed on 24 Oct. 2002, the contents of which are hereby incorporated by reference.

### BACKGROUND OF THE INVENTION

1. Field of the Invention

The invention relates to a method for radio system resource management in a cellular radio communication system configured as a multiple-carrier network.

2. Description of the Related Art

In radio communication systems, information (for example voice, image information, video information, SMS (Short Message Service) or other data) is transmitted with the aid of electromagnetic waves via a radio interface between transmitting and receiving stations. The radiation of electromagnetic waves in this case takes place at carrier frequencies that lie within the frequency band provided for the particular system. A radio communication system in this case includes subscriber stations, e.g. mobile stations, base stations, e.g. node B's and other network devices. The subscriber stations and base stations are connected to each other in a radio communication system via an interface.

Access by stations to the common transmission medium in these radio communication systems is controlled by multiple access (MA)/multiplexing methods. With these multiple accesses, the transmission medium can be divided between the stations in the time domain (Time Division Multiple Access, TDMA), in the frequency domain (Frequency Division Multiple Access, FDMA), in the code domain (Code Division Multiple Access, CDMA) or in the space domain (Space Division Multiple Access, SDMA). In this case, a subdivision of the transmission medium frequently takes place into frequency and/or time channels corresponding to the radio interface (for example with GSM, TETRA (Terrestrial Trunked Radio), DECT (Digital European Cordless Telephone), UMTS). Combinations of several of these methods are also used. To enable an economical use of the scarce radio resources, radio communication systems are provided with devices, such as control devices that manage radio system resources or assign resources. The resource of a radio interface in this case can, for example, be a time slot-frequency pair or also only one of the two (time slot or frequency).

Due to the increasing data rates, particularly in mobile radio systems, the bandwidth required steadily increases. To guarantee transmission of information that is as efficient as possible, the complete frequency band available is broken down into several sub-carriers (multiple carrier methods). The idea on which the multiple carrier systems, also known as OFDM (Orthogonal Frequency Division Multiplexing) is based, is to shift the initial problem of the transmission of a wideband signal to the transmission of a set of narrowband orthogonal signals. This also has the advantage that the complexity required at the receiver can be reduced.

With OFDM, pulse shapes that are almost rectangular are used for the sub-carriers. The frequency spacing of the sub-carriers is chosen in such a way that at the frequency at which the signal of a sub-carrier is evaluated the signals of the other sub-carriers are at zero crossing. This means that the sub-carriers are orthogonal relative to each other. A spectral overlapping of the sub-carriers and resulting high packing density of the sub-carriers is permissible because the orthogonal arrangement means that distinguishability between the individual sub-carriers is ensured. A spectral efficiency that is better than with the simple FDM (Frequency Division Multiplexing) is thus achieved.

The smallest geographical radio coverage area of a cellular radio communications system is called a radio cell. This area is served from a base station. The form of the radio cell is optimized so that a periodically recurring structure results. If a transfer to a different base station takes place during an active connection between a subscriber station and a base station, this is known as a handover. Performing a ‘seamless’ handover means that communication can be continued without interruption, if, for example, the subscriber station moves from one radio cell to an adjacent radio cell. The handover procedure can take place either from the base station or from the subscriber station. A handover is, e.g. triggered if the signal received from the subscriber station no longer ensures a proper transmission, or if the signal from a different base station is received with a greater amplitude than that from the base station currently connected to the subscriber station via the radio interface. A threshold value is used for this purpose, in order to avoid instabilities, such as the ping-pong effect.

With cellular radio communication systems there is a radio cell concept in the form of a honeycomb plan, for the optimum utilization of the radio frequencies, whereby the radio frequencies or the frequency band is used in other cells. This is expressed by the frequency reuse factor. By maintaining a certain protective distance before the reuse of a frequency, a frequency reuse factor is used that is greater than one. A frequency reuse factor of one corresponds to a case where each frequency uses the same frequency band.

In existing mobile radio systems of the second generation with frequency reuse factors greater than one, a subscriber station changes the carrier frequency in order to measure the amplitudes of the radio signals of another adjacent base station. If the actual received amplitude of the particular base station with which the subscriber station is in communication is greater than the measured amplitude of an adjacent station by a set threshold, a handover to a different base station is initiated. In systems of this kind, the subscriber station must measure all amplitudes received from the adjacent stations, in that it selects the relevant frequency and interrupts the connection to the supplying base station during the measuring procedure. This normally occurs in the periods in which there is no communication between the subscriber station and the particular base station, i.e. during so-called idle periods, so that a base station is unaware of the measurement by a subscriber station. Alternatively, a subscriber station can log off from the base station for these purposes, e.g. as provided by HIPERLAN/2. Measurements by the subscriber station on other frequencies requires time and signaling resources.

In the UMTS (Universal Mobile Telecommunications System) the mechanism of the soft-handover with macro diversity is used. A feature of this is that the same information signal is sometimes transmitted simultaneously from several base stations but with different spread factors. The subscriber station receives, decodes and combines all signals and is therefore able to increase the quality of reception. The disadvantage of this method is that several resources have to be used for the same information.

As a rule it can be assumed that the number of frequency bands per operator in the OFDM systems is limited to a single frequency band. Therefore every effort is made to use the available frequency band effectively. Because only a single frequency is available to the operator, a frequency reuse factor of one is present. To reduce the interference and amount of signaling, efficient handover methods are required.

### SUMMARY OF THE INVENTION

An object of the invention is to provide an effective method of the management of radio resources of the type named in the introduction and to demonstrate a corresponding radio communication system and control device of the type named in the introduction.

In accordance with the invention, the sub-carriers of the at least one frequency band of each radio cell are temporarily available for the transmission of information, and the several sub-carriers of the at least one frequency band are temporarily assigned to a number of radio cells in such a way that each of the assigned sub-carriers is available to a subset of the number of radio cells for transmission of information.

The number of radio cells in this case consists of at least two radio cells. A subset of this number must contain fewer radio cells than the total number.

An advantage of this method is that in principle a frequency reuse factor of one can be used. For many channels, such as certain broadcast channels, resources can, however, be saved if the sub-bands are not allowed to be used by all base stations. The invention enables the intensive utilization of resources with a frequency reuse factor of one in conjunction with a distribution of resources to the base stations for specific purposes.

In a development of the invention, at least one of the assigned sub-carriers is available to exactly one radio cell from the number of radio cells. It is also possible that each of the assigned sub-carriers is available to precisely one radio cell from the number of radio cells. Overall, therefore, due to the assignment each sub-carrier can be available to one or more radio cells from the number of radio cells, but not to all radio cells. Different sub-carriers can be simultaneously assigned different and different numbers of radio cells.

Advantageously, the number of radio cells includes adjacent radio cells. Radio cells are adjacent if they have a common boundary. In a network of hexagonal radio cells, each radio cell therefore has six neighboring radio cells. In a network of this kind, the number of radio cells consists advantageously of seven radio cells. A different number of radio cells is also possible.

In the assignment of the sub-carriers to n radio cells at least one sub-carrier available to a radio cell can advantageously have a frequency spacing of n sub-carriers. If the number of radio cells, for example, amounts to seven radio cells, the first sub-carrier, the eighth sub-carrier, the fifteenth sub-carrier, etc., can be assigned to the first radio cell. In each case, the nth sub-carrier is thus assigned to the particular radio cell. It is possible that in addition to the assignment of sub-carriers described, further sub-carriers can be available to a radio cell, so that not all sub-carriers have a frequency spacing of n sub-carriers. Thus, for example, the first and the second, the eighth and the ninth, the fifteen and sixteenth sub-carriers, etc. can be assigned to one radio cell.

In one embodiment of the invention, in the assignment of the sub-carriers, subcarriers available to at least one radio cell are sub-carriers adjacent in the frequency band. For example, sub-carriers one and two can be assigned to the first radio cell from the number of radio cells, sub-carriers three and four, etc. can be assigned to the second radio cell, with the numbering of sub-carriers increasing with increasing frequency. It is also possible to combine an assignment of adjacent sub-carriers and sub-carries with a frequency spacing.

In a development of the invention, the sub-carriers are assigned in accordance with an algorithm. Any rule for computing a numerical value that maps the number of sub-carriers to the number of radio cells, whereby only a subset of the number can be assigned to each sub-carrier, may be used. An example of an algorithm is the assignment of sub-carriers in accordance with codes. Thus, where there are four sub-carriers, the code 1,0,1,0 for example, means that the first and second sub-carriers are assigned to the particular radio cell. A method of this kind can be used in the context of the MC-CDMA (Multi Carrier Code Division Multiple Access) method.

Advantageously, the assigned sub-carriers are used by the base stations of the particular radio cells to transmit broadcast information. The broadcast information can be advantageously used to decide on handovers. A handover decision usually takes place depending on one or more measured values. These include, for example, measured values of the intensities of the broadcast channels transmitted from the base station. A decision as to whether a handover is to take place or not can then be made depending upon the result of the measurement. Where the handover decision is positive, a decision can be made as to the cell to which the handover is to take place.

In a development of the invention, the amplitudes of the broadcast information are determined in subscriber stations receiving the broadcast information. Advantageously, a metric of the amplitudes of the broadcast information transmitted from a base station on the sub-carriers available to it is determined. A metric can, for example, be a mean value. The metric can be determined either in the subscriber station or in the base station, or in a different device in the network. If the determination is not made in the subscriber station, the result of the measurements of the amplitudes must be transmitted from the subscriber station to the network.

The method can advantageously be used on an OFDM system.

The radio communication system of cellular construction has at least one control device in the network. In accordance with the invention, the at least one control device in the network has
means of at least temporarily assigning the several sub-carriers of the at least one frequency band to the radio cells in such a way that the sub-carriers are available to each radio cell for the transmission of information, and
means for the temporary assignment of the several sub-carriers of the at least one frequency band among a number of radio cells in such a way that each of the assigned sub-carriers is available to a subset of the number of radio cells for the transmission of information.

In accordance with the invention, the control device has
means for the temporary assignment of the several sub-carriers of the at least one frequency band to the radio cells in such a way that the sub-carriers are available to each radio cell for the transmission of information and
means for the temporary assignment of the several sub-carriers of the at least one frequency band among a number of radio cells in such a way that each of the assigned sub-carriers is available to a subset of the number of radio cells for the transmission of information.

### BRIEF DESCRIPTION OF THE DRAWINGS

These and other objects and advantages of the present invention will become more apparent and more readily appreciated from the following description of an exemplary embodiment, taken in conjunction with the accompanying drawings of which:

FIG. 1 is a block diagram of an extract of a cellular radio communication system,

FIG. 2 is a two-dimensional graph of a OFDM frame in accordance with the invention,

FIG. 3 is a two-dimensional graph of amplitudes transmitted from base stations, and

FIG. 4 is a two-dimensional graph of amplitudes received from a subscriber station.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

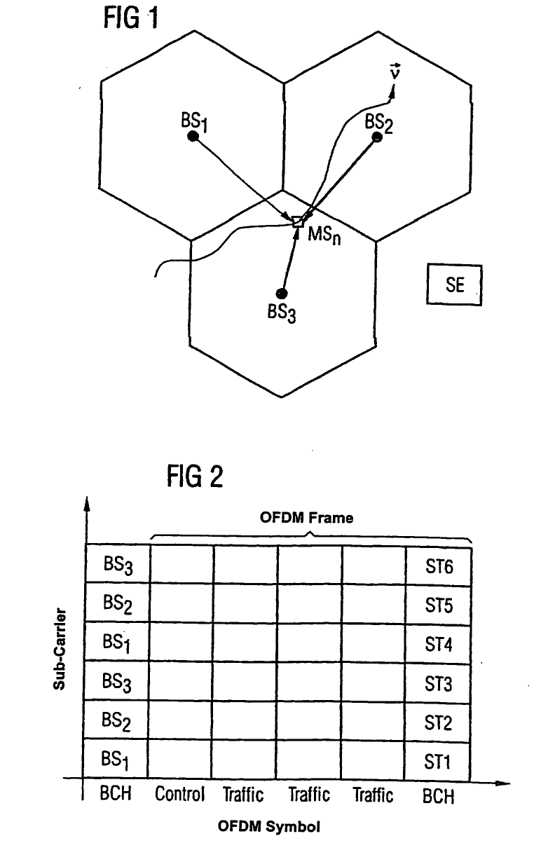

The following example of an embodiment is a cellular OFDM radio communication system, synchronized with regard to time and frequency. A frequency band with a frequency reuse factor of one is used in this case. FIG. 1 is a schematic of an extract from a cellular system of this kind with three hexagonal radio cells. A subscriber station MSₙ moves along a path \vec{v}. At its actual stopping point, it receives signals from a first base station BS₁, from a second base station BS₂ and from a third base station BS₃. The subscriber station MSₙ is actually connected to the third base station BS₃ corresponding to its location. The arrows of different thicknesses show the received amplitude of the signals originating from the particular base station BS₁, BS₂ and BS₃. It can be seen that although the subscriber station BSₙ is located in the cell of the third base station BS₃, the received amplitude of the signals transmitted from the second base station BS₂ is greatest. This effect can, for example, occur due to shadowing and multipath propagation. In the circumstances shown in FIG. 1, it is most favorable if a handover takes place from the third base station BS₃ to the second base station BS₂.

A control device SE is part of the radio communication system. It is (not shown in FIG. 1) connected directly, or indirectly i.e. via other stations, to the base stations BS1, BS2 and BS3. It can also have a connection to the core network (not illustrated). The control device SE can have any spatial position within the radio communication system. It can also be integrated into other devices in the network. The purpose of this control device SE is to assign the radio resources to the different radio cells. It thus decides which sub-carriers are assigned to each individual base station BS1, BS2 and BS3 or whether they are available to only part of the base stations. These decisions are then transmitted to the base stations.

FIG. 2 shows an OFDM frame, OFDM Frame. The OFDM symbols are shown on the horizontal axis that corresponds to the time axis. The individual OFDM symbols of a frame OFDM Frame can be assigned to different functions. The illustration shows the use of one symbol for signaling information Control, the use of three symbols for useful information Traffic and the use of one symbol for the broadcast BCH of the particular base station. Other uses of the symbols are however also possible. The OFDM symbols are transmitted in succession. Thus, FIG. 2 shows, before the start of the OFDM frame, OFDM Frame, within which the first symbol for useful information Traffic is used, an OFDM symbol of the preceding OFDM frame that is used for the broadcast BCH.

An OFDM symbol consists of several sub-carriers ST1, ST2, ST3, ST4, ST5 and ST6, that are shown on the vertical axis of FIG. 2. The example shows six sub-carriers. The designation of the six sub-carriers ST1, ST2, ST3, ST4, ST5 and ST6 is entered in the right of the two symbols used for the broadcast BCH.

The broadcast information is transmitted from the base stations, so that handover decisions can be made with the aid of measurements of amplitudes received from the subscriber stations. As part of this, the channel quality of the various base stations located in the vicinity of the subscriber station is estimated. To do this, it is necessary to know which base station the received broadcast signal originates from. A possible solution to this problem is to provide a separate OFDM symbol for broadcast transmission for each base station. With regard to the time sequence, this corresponds to the transmission, in succession, of broadcast signals of the various base stations. Therefore, the duration of a few OFDM symbols must extend until all the information required for a handover can be transmitted and processed. Furthermore, during this broadcast, the scarce radio resources use symbols exclusively for signaling information and not for useful information.

In accordance with the invention, adjacent base stations use the same OFDM symbol to transmit their broadcast information. The sub-carriers ST1, ST2, ST3, ST4, ST5 and ST6 of this symbol are assigned to these base stations for this purpose. In the simplified example with three radio cells shown in FIG. 1, the first base station BS1, for example, transmits in the first sub-carrier ST1, the second base station BS2 in the second sub-carrier ST2, the third base station BS3 in the third sub-carrier ST3 and again the first base station BS1 transmits in the fourth sub-carrier ST4, the second base station BS2 again the fifth sub-carrier ST5, etc. Each base station thus transmits on every third sub-carrier. In the left of the two OFDM symbols, shown in FIG. 2, used for the broadcast BCH, the base stations BS1, BS2, BS3 assigned to them are entered in the sub-carriers ST1, ST2, ST3, ST4, ST5 and ST6. There is then a gapless OFDM symbol for the subscriber station. This method can be easily used for several cells. Because of this staggered arrangement, the subscriber station obtains from only one OFDM symbol information regarding the received amplitude of the radio channels of adjacent base stations.

Within the network formed by the radio cells, clusters of adjacent cells are combined, to which the sub-carriers ST1, ST2, ST3, ST4, ST5 and ST6 are then assigned. This cluster repeats itself periodically in the network of radio cells. Advantageously, the assignment of the sub-carriers ST1, ST2, ST3, ST4, ST5 and ST6 takes place in the same way in each cluster. It is, however, also possible to use different assignment methods in different clusters.

The described method of assignment of the sub-carriers ST1, ST2, ST3, ST4, ST5 and ST6 to the adjacent base stations BS1, BS2, BS3 is only an example. Further variations of this are conceivable and can be used depending on the application. Furthermore, the mode of assignment can also vary over time. Thus, for example, the assignment shown in FIG. 2 can take place in a first OFDM frame OFDM Frame, and in the succeeding OFDM frame OFDM Frame the assignment can take place offset by one sub-carrier, so that a rotation of the sub-carriers ST1, ST2, ST3, ST4, ST5 and ST6 assigned for the broadcast BCH takes place over time.

The dimensioning of an OFDM system means that adjacent sub-carriers are correlated. If a sub-carrier is heavily attenuated by multi-path propagation, this mainly affects one group of adjacent sub-carriers. It is, however, possible that the remaining sub-carriers are just slightly attenuated. If therefore, only one associated group of adjacent sub-carriers is used as a basis for the broadcast information, only a limited objective estimation of the channel quality based on amplitude measurements is possible. With the method described above, the supporting values for determining the channel quality are distributed over the complete bandwidth of the frequency band, which makes sure that the accuracy of the estimation of the channel quality is increased.

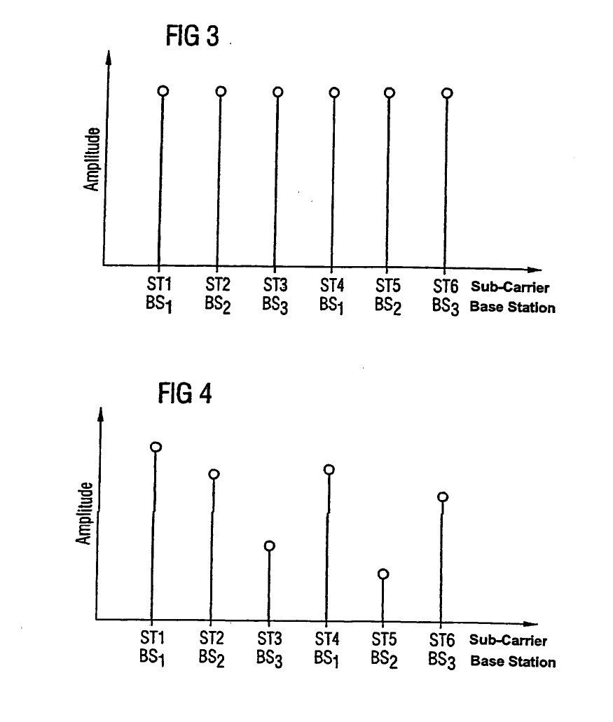

To be able to effectively estimate the channel quality, the base stations must transmit on each sub-carrier at a fixed amplitude known to the subscriber stations. FIG. 3 shows the amplitude of the broadcast signals transmitted/from the various base stations BS1, BS2, BS3. In accordance with the assignment of the sub-carriers ST1, ST2, ST3, ST4, ST5 and ST6 to the three base stations BS1, BS2, BS3, shown in FIG. 2, the first amplitude corresponds to the first amplitude used by the first base station BS1 on the first sub-carrier ST1, the second amplitude corresponds to the amplitude used by the second base station BS2 on the second sub-carrier ST2, etc. Due to multi-path propagations and shadowing, a subscriber station, for example, receives a signal, the amplitude of which is shown in FIG. 4. The amplitudes of the individual sub-carriers ST1, ST2, ST3, ST4, ST5 and ST6 in this case vary according to the frequency dependency of the attenuation. By simple averaging, a metric can be formed on the basis of which the decision for a handover can be derived. To do this, for example, the amplitudes of all broadcast signals of a base station are added and this total is divided by the number of sub-carriers used by this base station for broadcast transmission.

The method can then also be advantageously used if a sub-carrier is assigned to several radio cells for the broadcast transmission. In this case, the separation of the signals of the individual base stations can e.g. take place by a specific code.

Overall, the provision of the information necessary for the handover decision was reduced to a single OFDM symbol of the signaling expenditure. This serves as a basis for reducing interference and enabling a higher spectrum efficiency

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-14. (canceled)

15. A method for managing radio resources in a cellular radio communications system configured as a multi-carrier system, comprising:
transmitting information on at least one frequency band having sub-carriers, the sub-carriers of the at least one frequency band being temporarily available to each radio cell for transmission of information; and
temporarily assigning the sub-carriers of the at least one frequency band to at least two radio cells with each of the sub-carriers available to a subset of the at least two radio cells for transmission of information.

16. A method in accordance with claim 15, wherein said assigning makes at least one of the sub-carriers available to exactly one radio cell in the at least two radio cells.

17. A method in accordance with claim 16, wherein said assigning makes each of the sub-carriers available to exactly one radio cell in the at least two radio cells.

18. A method in accordance with claim 15, wherein the at least two radio cells are adjacent radio cells.

19. A method in accordance with claim 15, wherein said assigning of the sub-carriers is to n radio cells, making assigned sub-carriers available to at least one radio cell have a frequency spacing of n sub-carriers.

20. A method in accordance with claim 15, wherein said assigning makes at least some adjacent sub-carriers in the frequency band available to at least one radio cell.

21. A method in accordance with claim 15, wherein said assigning of the sub-carriers takes place in accordance with an algorithm that includes use of a code.

22. A method in accordance with claim 21, wherein said assigning makes the sub-carriers used by base stations of particular radio cells available for transmission of broadcast information.

23. A method in accordance with claim 22, wherein the broadcast information is used to decide on handovers.

24. A method in accordance with claim 23, further comprising determining amplitudes of the broadcast information in subscriber stations receiving the broadcast information.

25. A method in accordance with claim 24, further comprising determining a metric of the amplitudes of the broadcast information transmitted from one of the base stations on the sub-carriers available to the one of the base stations.

26. A method in accordance with claim 15, wherein the cellular radio communications system is an orthogonal frequency division multiplexing system.

27. A radio communication system of cellular construction configured as a multi-carrier system using at least one frequency band having sub-carriers for transmission of information, comprising:
at least two radio cells; and
at least one control device assigning the sub-carriers of the at least one frequency band to said at least two radio cells so that temporarily the sub-carriers are available to each radio cell for transmission of information, and that temporarily each of the sub-carriers is available to a subset of the at least two radio cells for transmission of information.

28. A control device of a radio communication system of cellular construction, that is configured as a multi-carrier system having at least two radio cells with at least one frequency band having sub-carriers for transmission of information in the at least two radio cells, comprising:
means for temporarily assigning the sub-carriers of the at least one frequency band to the at least two radio cells so that the sub-carriers are available to each radio cell for the transmission of the information; and
means for temporarily assigning the sub-carriers of the at least one frequency band among the at least two radio cells so that each of the sub-carriers is available to a subset of the at least two radio cells for the transmission of the information.
